(19) United States
(12) Patent Application Publication
(10) Pub. No.: US 2025/0205696 A1
(43) Pub. Date: Jun. 26, 2025

(54) METHOD OF SYNTHESIZING HIGH-EFFICIENCY BIFUNCTIONAL ELECTROCATALYSTS

(71) Applicant: University of Central Florida Research Foundation, Inc., Orlando, FL (US)

(72) Inventors: Yang Yang, Orlando, FL (US); Jinfa Chang, Orlando, FL (US)

(21) Appl. No.: 19/081,067

(22) Filed: Mar. 17, 2025

Related U.S. Application Data
(63) Continuation of application No. 17/303,005, filed on May 18, 2021, now Pat. No. 12,251,692.
(60) Provisional application No. 63/026,471, filed on May 18, 2020.

(51) Int. Cl. B01J 37/34; B01J 27/185; B01J 35/00; B01J 35/30; B01J 37/02; B01J 37/28; B82Y 40/00; C25B 1/04; C25B 11/091

(52) U.S. Cl. CPC B01J 37/348; B01J 27/1853; B01J 35/00; B01J 35/30; B01J 37/0238; B01J 37/28; C25B 1/04; C25B 11/091; B82Y 40/00

(57) ABSTRACT

Described herein relates to a method that may be used for synthesizing a bifunctional electrocatalyst for electrochemical water splitting. The method may involve anodically converting an electrodeposited iron-nickel alloy film into an iron-nickel-oxygen nanofilm, followed by sequential phosphorization and/or selenylation treatments via chemical vapor deposition to form a quaternary iron-nickel phosphoselenide nanoporous film. This self-supported catalyst can facilitate both hydrogen evolution and oxygen evolution reactions, improving electrolysis efficiency. The inclusion of selenium may enhance electrical conductivity and stabilize catalytic performance, while the nanoporous structure can optimize mass transport. The film may be used as both anode and cathode in a two-electrode electrolyzer, enabling hydrogen production from pure water or seawater. Notably, the catalyst can demonstrate high turnover frequency and low overpotential, potentially surpassing conventional noble-metal-based catalysts. The system's stability under prolonged operation may underscore its potential for scalable hydrogen generation, reducing reliance on fossil fuels and advancing renewable energy applications.

### CROSS-REFERENCE TO RELATED APPLICATIONS

This Nonprovisional Patent Application is a continuation of and claims the benefit of and priority to U.S. Nonprovisional patent application Ser. No. 17/303,005 entitled “METHOD OF SYNTHESIZING HIGH-EFFICIENCY BIFUNCTIONAL ELECTROCATALYSTS” filed May 18, 2021 by the same inventors, which claims the benefit of and priority to U.S. Provisional Patent Application No. 63/026,471 entitled “METHOD OF SYNTHESIZING HIGH-EFFICIENCY BIFUNCTIONAL ELECTROCATALYSTS” filed May 18, 2020 by the same inventors, all of which are incorporated herein by reference, in their entireties, for all purposes.

### BACKGROUND OF THE INVENTION

### 1. Field of the Invention

This invention relates, generally, to high-efficiency electrocatalysts. More specifically, it relates to methods of synthesizing high-efficiency bifunctional electrocatalysts, using quaternary iron/nickel phosphoselenide nanoporous films (FeNi—PSe NFs) that facilitate renewable energy-based hydrogen production.

### 2. Brief Description of the Prior Art

Hydrogen (H₂) is a promising alternative to traditional fossil fuels because of its high energy density of 142 MJ kg⁻¹ and clean emissions. Electrochemical water splitting in alkaline media is a critical approach to produce high-purity H₂ without carbon emission. Currently, platinum group metal (PGM) catalysts such as Pt and IrO₂ are dominantly used for water electrolysis due to their good electrical conductivity and proper electronic structures for hydrogen evolution reactions and oxygen evolution reactions (HER and OER), respectively. However, water electrolysis cannot compete with the traditional mass production of H₂ from fossil fuels by steam methane reforming and coal gasification because of the high cost and low efficiency of PGM catalysts in actual electrolyzers. Accordingly, it is urgent and necessary to develop cost-effective, high-efficiency, and stable non-PGM catalysts for practical water electrolysis.

In addition, it is desired to design nanostructured bifunctional catalysts in order to catalyze both HER and OER under the same electrolyte circumstance, thereby simplifying the electrolyzer design and facilitating the mass/charge transfer. However, designing high-efficiency bifunctional catalysts is challenging due to the different surface active sites and reaction kinetics for HER and OER catalysts in an integrated electrolyzer. Moreover, current state-of-the-art HER and OER catalysts are typically effective in only one of strongly acidic or alkaline solutions, leading to contamination and electrolyzer corrosion. For example, transition metal phosphides (TMPs) are considered as efficient HER catalysts due to the co-existence of proton-acceptor sites (negatively charged P atoms) and hydride-acceptor sites (isolated M atoms; M=Fe, Co, Ni, and other transition metals) on the material surface, resulting in a facilitated HER through an ensemble effect. Nevertheless, the surfaces of TMPs gradually oxidize in an ambient atmosphere, leading to HER performance decay. On the other hand, the slightly oxidized surfaces of TMPs are usually regarded as the active sites for OER, meaning that the TMPs could be used as bifunctional catalysts if a proper trade-off between HER and OER performance is achieved.

Accordingly, what is needed is a bifunctional catalyst that can efficiently catalyze overall water splitting using pure water or seawater to significantly increase the lifetime of the electrolyzer and greatly reduce the cost for hydrogen production. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need for an efficient and reusable electrolyzer and method of splitting water for hydrogen production is now met by a new, useful, and nonobvious invention.

The novel method includes the formation of a self-supported quaternary iron-nickel phosphoselenide nanoporous film. The film is formed by anodically converting an electrodeposited iron-nickel alloy film to an iron-nickel-oxygen nanofilm. The iron-nickel-oxygen nanofilm is thermally treated via a phosphorization treatment followed by a selenylation treatment using chemical vapor deposition, forming an iron-nickel-phosphorus nanofilm. The iron-nickel-phosphorus nanofilm is then formally treated with selenium vapor to partially substitute selenium for phosphorus, forming a quaternary iron-nickel phosphoselenide nanoporous film bifunctional catalyst. The selenium stabilizes the catalyst and improving the electrical conductivity of the catalyst. A plurality of pores are formed through the quaternary iron-nickel phosphoselenide nanoporous film, such that the plurality of pores improve a transportation of mass through the nanoporous film. In an embodiment, the film includes a thickness of 5 μm; in an embodiment, the firm is disposed on a surface of an unreacted iron-nickel alloy matrix. An embodiment of the film includes at least 10% iron by volume, at least 65% nickel by volume, at least 0.5% phosphorus by volume, and at least 23% selenium by volume.

The quaternary iron-nickel phosphoselenide nanoporous film is used as an anode and a cathode in a two-electrode electrolytic cell. The two-electrode electrolytic cell is subjected to a water source, such as seawater, and the quaternary iron-nickel phosphoselenide nanoporous film splits water molecules in the water source. The quaternary iron-nickel phosphoselenide nanoporous film is capable of both hydrogen evolution reactions and oxygen evolution reactions because the quaternary iron-nickel phosphoselenide nanoporous film includes an oxidized surface as an active site for the oxygen evolution reactions, thereby improving electrolysis efficiency. Specifically, the hydrogen evolution reactions convert the amount of water into hydrogen fuel that is usable as a renewable energy source.

An object of the invention is to reduce the cost of hydrogen production for energy uses by efficiently catalyzing water splitting using pure water or seawater, thereby significantly increasing the lifetime of an electrolyzer used in the water splitting method.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 depicts x-ray diffraction patterns, comparing FeNi films, FeNi—O films, FeNi—P films, FeNi—Se films, and FeNi—PSe nanofilms, according to embodiments of the present disclosure.

FIG. 2 is a scanning electron microscopy image of a FeNi—PSe nanofilm, according to embodiments of the present disclosure.

FIG. 3 is a graphical representation of high-resolution XPS profiles for a FeNi—PSe nanofilm, according to embodiments of the present disclosure.

FIG. 4 depicts polarization curves, Tafel plots, turnover frequencies, and reaction pathways for a FeNi—PSe nanofilm, according to embodiments of the present disclosure.

FIG. 5 is a graphical representation of electrochemical performance of FeNi—PSe nanofilms for overall water splitting implementations, according to embodiments of the present disclosure.

FIG. 6 graphically compares Ni—PSe NFs with FeNi—PSe NFs by comparing hydrogen evolution reactions and oxygen evolution reactions thereof, according to embodiments of the present disclosure.

FIG. 7 depicts scan-rate dependent cyclic voltammetry values for FeNi—PSE NFs, FeNi—P NFs, and FeNi—Se NFs, at scan rates of 10, 20, 40, 60, 80, and 100 mVs⁻¹, according to embodiments of the present disclosure.

FIG. 8 is a graphical representation of high-resolution XPS profiles for a FeNi—PSe nanofilm after hydrogen evolution reaction testing, according to embodiments of the present disclosure.

FIG. 9 is a graphical representation of high-resolution XPS profiles for a FeNi—PSe nanofilm after oxygen evolution reaction testing, according to embodiments of the present disclosure.

FIG. 10 is a graphical representation of water electrolyzer performance using FeNi—PSe nanofilms, according to embodiments of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention.

As such, elements/components shown in diagrams are illustrative of exemplary embodiments of the disclosure and are meant to avoid obscuring the disclosure. Any headings, used herein, are for organizational purposes only and shall not be used to limit the scope of the description or the claims.

Furthermore, the use of certain terms in various places in the specification, described herein, are for illustration and should not be construed as limiting. For example, any reference to an element herein using a designation such as “First,” “Second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements

Reference in the specification to “One Embodiment,” “Preferred Embodiment,” “An Embodiment,” or “Embodiments” means that a particular feature, structure, characteristic, or function described in connection with the embodiment is included in at least one embodiment of the disclosure and may be in more than one embodiment. The appearances of the phrases “In One Embodiment,” “In An Embodiment,” “In Embodiments,” “In Alternative Embodiments,” “In An Alternative Embodiment,” or “In Some Embodiments” in various places in the specification are not necessarily all referring to the same embodiment or embodiments. The terms “Include,” “Including,” “Comprise,” and “Comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

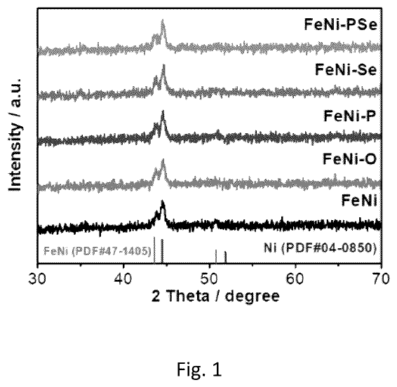

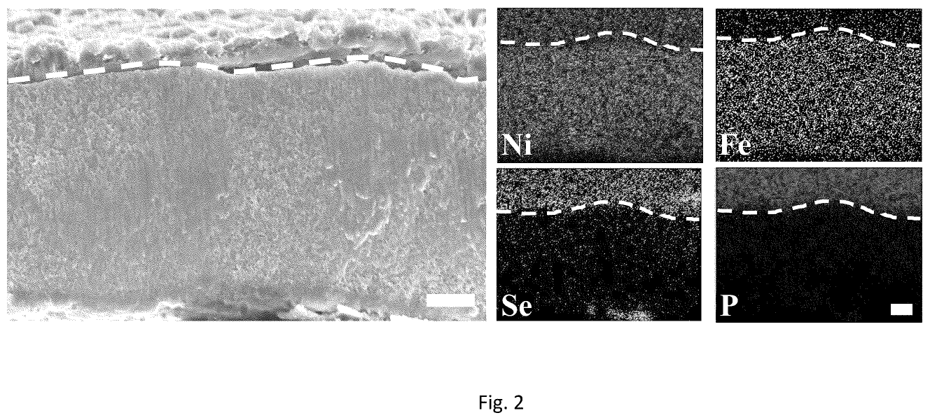

Accordingly, the relevant descriptions of such features apply equally to the features and related components among all the drawings. For example, any suitable combination of the features, and variations of the same, described with components illustrated in FIG. 1, can be employed with the components of FIG. 2, and vice versa. This pattern of disclosure applies equally to further embodiments depicted in subsequent figures and described hereinafter. It should be understood that the figures presented are not meant to be illustrative of actual views of any particular portion of the actual structure or method but are merely idealized representations employed to more clearly and fully depict the present invention defined by the claims below.

### Definitions

As used in this specification and the appended claims, the singular forms “A,” “An,” and “The” include plural referents unless the content clearly dictates otherwise. As used in this specification and the appended claims, the term “Or” is generally employed in its sense including “And/Or” unless the context clearly dictates otherwise.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

As used herein, the terms “About,” “Approximately,” or “Roughly” generally refer to being within an acceptable error range (i.e., tolerance) for the particular value as determined by one of ordinary skill in the art, which will depend in part on how the value is measured or determined (e.g., the limitations of a measurement system) (e.g., the degree of precision required for a particular purpose, such as synthesizing high-efficiency bifunctional electrocatalysts). As used herein, “about,” “approximately,” or “roughly” refer to within ±25% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “At Least,” “Greater Than,” or “Greater Than Or Equal To” precedes the first numerical value in a series of two or more numerical values, the term “At Least,” “Greater Than” or “Greater Than Or Equal To” applies to each of the numerical values in that series of numerical values. For example, greater than or equal to 1, 2, or 3 is equivalent to greater than or equal to 1, greater than or equal to 2, or greater than or equal to 3.

Wherever the term “No More Than,” “Less Than,” or “Less Than Or Equal To” precedes the first numerical value in a series of two or more numerical values, the term “No More Than,” “Less Than” or “Less Than Or Equal To” applies to each of the numerical values in that series of numerical values. For example, less than or equal to 1, 2, or 3 is equivalent to less than or equal to 1, less than or equal to 2, or less than or equal to 3.

### High-Efficiency Bifunctional Electrocatalysts Synthesis

The present invention includes the design of bifunctional catalysts for water splitting by modifying the electronic structure of the catalyst. That catalyst used herein is a quaternary FeNi—PSe nanoporous film (FeNi—PSe NF). Metal phosphoselenides are used due to the weaker bond strength of Se—H (276 KJ/mol) as compared with P—H (322 KJ/mol), leading to a better capability for the selenides to capture the reactants and accelerate a subsequent discharge step. Meanwhile, the slightly oxidized FeNi—PSe surface serves as an active site for OER, making HER and OER well-balanced. Furthermore, Fe-doping was used to further improve the OER activities and conductivities of Ni—PSe under alkaline media by forming high valence nickel. The designed FeNi—PSe NFs are self-supported and can be directly used as bifunctional catalysts without adding any additives, allowing the direct investigation of the synergistic effects among the quaternary elements (Ni, Fe, Se, and P) for overall water splitting without interference from carbon and other additives.

The quaternary FeNi—PSe NFs were synthesized by anodically converting the electrodeposited FeNi alloy films (atomic ratio of Fe:Ni=15:85) to FeNi—O NFs followed by thermal treatments (firstly phosphorization, followed by selenylation) using a chemical vapor deposition (CVD) apparatus. Due to the oxygen/moisture-sensitivity of TMPs, the FeNi—P NFs were further thermally treated under selenium vapor in order to partially substitute P by Se. The incorporation of Se in the quaternary FeNi—PSe NFs plays dual roles of stabilizing the catalysts in the air and improving the electrical conductivity of the catalysts. The methods of synthesizing the Fe—Ni—PSe NFs are described in greater detail herein below.

### Synthesis of FeNi—PSe Nanofilms

FeNi alloys were synthesized in an electrolyte bath prepared in an aqueous plating solution by dissolving Ni₂SO₄·₆H₂O, NiCl₂·₆H₂O, FeSO₄·₇H₂O, H₃BO₃, Na₃C₆H₅O₇·₂H₂O and saccharin with a certain amount in distilled water and then stirring for 30 min at room temperature. A bottom-up electrochemical deposition of FeNi alloy films was performed in a home-made two-electrode cell with stainless steel substrate as the cathode and a Pt mesh as the anode at a current density of 25 mA cm⁻² for 20 min. FeNi—O NFs were then synthesized via a top-down anodic treatment at a constant voltage of 20 V for 20 min in an electrolyte of 0.2 M NH₄F and 2 M H₂O in ethylene glycol.

The obtained FeNi—O films were placed at the downstream side while NaH₂PO₂ was placed at the upstream side in a tube furnace. The tube was evacuated to 50 mTorr for at least 10 min and then purged with Ar to remove the residual air. Then, the furnace upstream and downstream of the tube furnace was maintained at 250° C. and 300° C. for 15 min with a heating rate of 5° C. min⁻¹. During the reaction, Ar (100 sccm) was used as a carrier gas; after cooling to room temperature, Se powder was placed at the upstream to replace the residual NaH₂PO₂, and the furnace upstream and downstream of the tube furnace were both kept at 300° C. for another 15 min to obtain FeNi—PSe NFs. As control experiments, FeNi—P NFs and FeNi—Se NFs were prepared without using Se and P sources, respectively.

As shown in FIG. 1, only the characteristic peaks of the metallic FeNi films could be found from the XRD patterns due to the much higher contents and stronger intensities for the diffraction peaks of FeNi films. The cross-sectional scanning electron microscopic (SEM) images and elemental mapping, shown in FIG. 2, indicate the formation of a porous structure throughout the entire film with a total thickness of 5 μm, including a thin layer of FeNi—PSe NFs (600 nm) on the surface of unreacted FeNi alloy matrix. The pores help to accelerate the mass transportation through the film. The contents of Fe, Ni, P, and Se in the FeNi-PSe NFs were estimated to be 10.5 wt %, 65.1 wt %, 0.7 wt %, and 23.7 wt %. The much higher content of Se than that of P is due to the substitution of P with Se during the CVD treatments.

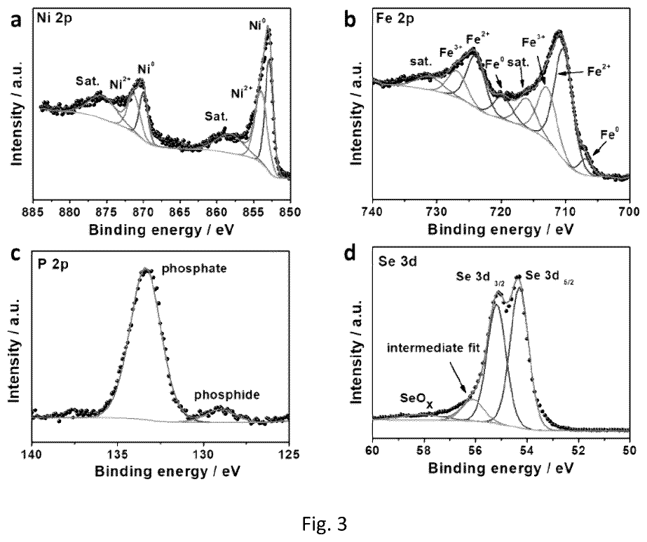

FIG. 3 shows the high-resolution XPS Ni 2p profile for the FeNi—PSe NFs (in section A) having three sets of peaks at 853.0 eV/870.3 eV, 854.5 eV/872.8 eV, and 859.0 eV/876.3 eV corresponding to the metallic Ni⁰, Ni²⁺, and the Ni satellite peaks, respectively. The XPS Fe 2p profile (in section B) shows peaks located at 706.1 eV and 712.4 eV, which are attributed to the Fe⁰ and Fe³⁺, respectively. The XPS P 2p profile (in section C) shows that the peaks located at 129.0 eV and 133.4 eV are attributed to the phosphide and phosphate species, respectively. The XPS Se 3d profile (in section D) shows the peaks at 54.2 eV and 55.0 eV corresponding to Se 3d_{5/2} and Se 3d_{3/2}, respectively, which are the core level bands of Se 3d in NiSe₂/FeSe₂. In addition, the intermediate fitting lines at 55.9 eV and 58.3 eV are associated with the slightly oxidized surface.

### Performance of the Catalysts

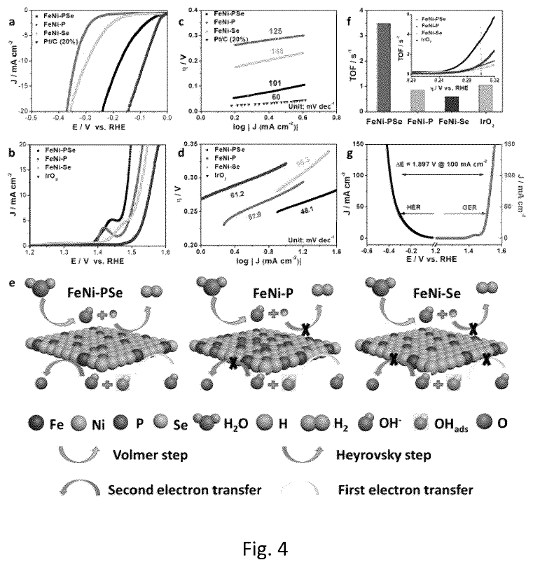

The electrochemical HER and OER performance of the catalysts was firstly studied in a three-electrode system using Ar-saturated 1 M KOH solution as an electrolyte to make a comparison with the commercial Pt/C (platinum decorated carbon) (20 wt %) and IrO₂ benchmark catalysts. The onset potential for the FeNi—PSe NFs (shown in Section A of FIG. 4) is 29 mV, which is much lower than those of FeNi—P NFs (230 mV) and FeNi—Se NFs (135 mV), and very close to the commercial Pt/C (0 mV). To reach a current density of 10 mA cm⁻², the FeNi—PSe NFs, FeNi—P NFs, and FeNi—Se NFs require η of 172 mV, 337 mV, and 295 mV, respectively. Tafel slopes are usually used to detect the rate-determining step (RDS) for HER through the following pathways:

$$* + {H}_{2} O + {e}^{-} \to {OH}^{-} + * {H}_{ads} Volmer step \qquad ( 1 )$$

$$* {H}_{ads} + {H}_{2} O + {e}^{-} \to * + {OH}^{-} + {H}_{2} Heyrovsky step \qquad ( 2 )$$

$$2 * {H}_{ads} \to 2 * + {H}_{2} Tafel step \qquad ( 3 )$$

where * denotes the surface active site. As shown in Section C of FIG. 4, the FeNi—PSe NFs have a much smaller Tafel slope (101 mV dec⁻¹) than FeNi—P NFs (125 mV dec⁻¹) and FeNi—Se NFs (148 mV dec⁻¹), indicating the intrinsically favorable kinetics of FeNi—PSe NFs for HER. Hence, the RDS for FeNi—PSe NFs is dominated by the Heyrovsky step, whereas the RDS for FeNi—P NFs and FeNi—Se NFs is controlled by the Volmer step (Section E of FIG. 4).

The electrochemical OER performance of the catalysts was also examined by linear sweep voltammograms (LSV, as shown in Section B of FIG. 4) and Tafel plots (Section D of FIG. 4). The oxidation peaks located in the potential range of 1.4-1.45 V are ascribed to the oxidation of Ni²⁺ to Ni³⁺. The FeNi—PSe NFs show much lower overpotentials to reach the current densities of 10 mAcm⁻² and 20 mAcm⁻² (η of 254 mV and 267 mV, respectively) than those of FeNi—P NFs (η of 279 mV and 332 mV, respectively) and FeNi—Se NFs (η of 290 mV and 317 mV, respectively). It should be noted that the OER performance of FeNi—P NFs is better than the FeNi—Se NFs because it is easier to form the oxidized surface on the FeNi—P NFs for OER. More importantly, all the nanoporous film catalysts show better OER performance than the commercial IrO₂. The Tafel slope of FeNi—PSe NFs (48.1 mV dec⁻¹) is much lower than those of FeNi—P NFs (57.9 mV dec⁻¹) and FeNi—Se NFs (96.3 mV dec⁻¹), indicating different RDS and reaction kinetics for OER (shown in Section E of FIG. 4) according to the most accepted four-electron reaction steps in alkaline solution:

$$* + {OH}^{-} \to * {OH}_{ads} + {e}^{-} \qquad ( 4 )$$

$$* {OH}_{ads} + {OH}^{-} \to * O + {e}^{-} + {H}_{2} O \qquad ( 5 )$$

$$* O + {OH}^{-} \to * OOH + {e}^{-} \qquad ( 6 )$$

$$* OOH + + {OH}^{-} \to * + {O}_{2} + {e}^{-} + {H}_{2} O \qquad ( 7 )$$

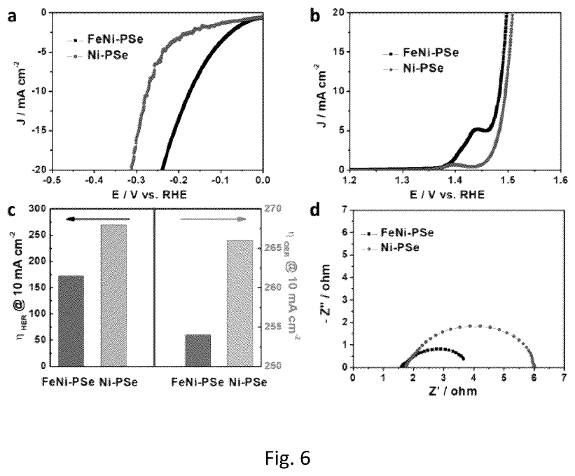

Typically, in a multi-electron involved OER process, the Tafel slopes of 24 mV dec⁻¹, 40 mV dec⁻¹, and 60 mV dec⁻¹ imply that the third-electron transfer, the second-electron transfer, and the chemical step following the first-electron transfer are the RDS, respectively. Distinctly, the FeNi—PSe NFs have a Tafel slope of 48.1 mV dec⁻¹, indicating that the second-electron transfer process is the RDS (shown in Section E of FIG. 4). However, the RDS for FeNi—P NFs is the first-electron transfer process. The large Tafel slope of FeNi—Se NFs indicates that the RDS is limited by the initial step during which the catalyst surface is strongly bonded with —OH groups. In contrast, the small Tafel slope of FeNi—PSe NFs suggests that the RDS is at the final step of the multiple-electron transfer processes, proving an excellent OER activity. As compared to HER, OER is kinetically sluggish and eventually determines the efficiency of the overall water splitting. In order to further examine the OER activities of the catalysts, turnover frequency (TOF) was calculated as shown in Section F in FIG. 4. The TOF at the overpotential of 0.3 V for FeNi—PSe NFs is about 3.48 s⁻¹, which surpasses FeNi—P NFs (0.85 s⁻¹), FeNi—Se NFs (0.59 s⁻¹), and IrO₂ (1.06 s⁻¹) by 4.1 times, 5.9 times, and 3.3 times, respectively. The high TOF of FeNi—PSe NFs undisputedly suggests a supreme activity towards OER, contributing to the improved electrolysis efficiency. The bifunctional HER/OER activities of FeNi—PSe NFs were further investigated in a three-electrode system, as shown in Section G of FIG. 6. A potential of 1.897 V is required to deliver a high current density of 100 mA·cm⁻² for overall water splitting.

### Water Splitting Performance

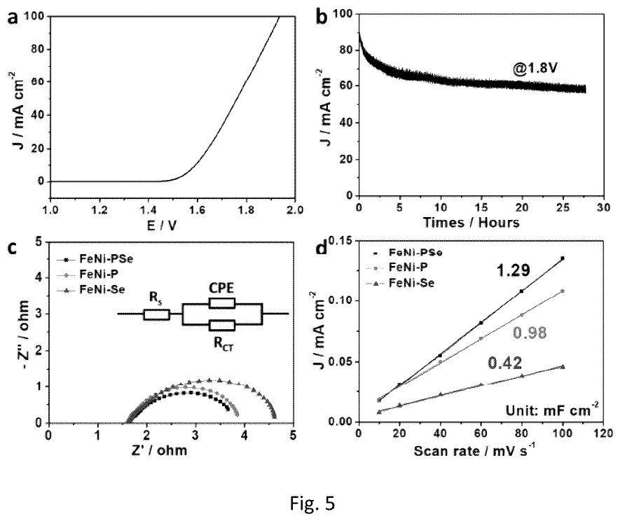

A two-electrode electrolytic cell using the FeNi—PSe NFs as both anode and cathode was employed to study the practical water splitting performance. The potentials of 1.59 V and 1.93 V were required to deliver current densities of 10 mA cm⁻² and 100 mA cm⁻², respectively (as shown in Section A of FIG. 5), superior to the state-of-the-art bifunctional catalysts for overall water splitting. A further I-t curve testing (shown in Section B of FIG. 5) shows that approximately 66% current can be well maintained at 1.8 V for more than 100000 s (27.7 hours).

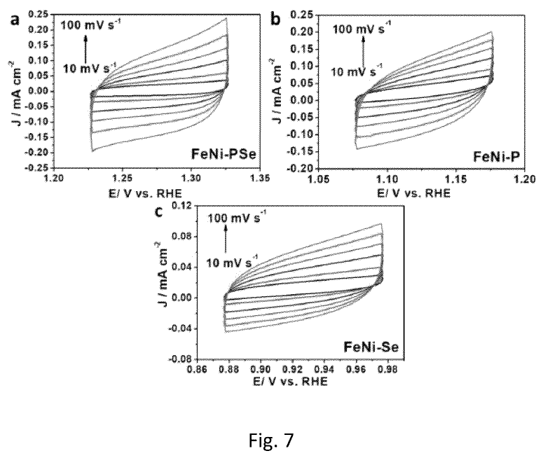

Electrochemical impedance spectroscopy (EIS) was used to probe the reaction kinetics for the catalysts. The Nyquist plots (shown in Section C of FIG. 5) and the corresponding equivalent circuit at an overpotential of 0.3 V shows that the system resistance (Rₛ) is approximately equal for all the catalysts (1.6 22, shown in Table 1 below). The charge transfer resistance (RCT) of FeNi—PSe NFs is much smaller than those of two control catalysts, indicating a greatly enhanced conductivity, facilitated electron transfer, and thus improved catalytic activity for water splitting by forming quaternary alloy phosphoselenide. In addition, the Ni—PSe NFs without Fe-doping (shown in Sections A-C of FIG. 6) show a much inferior HER/OER performance than the FeNi—PSe NFs due to the low conductivity (shown in Section D of FIG. 6). The double-layer capacitance (CDL) calculated from the CV curves (shown in FIG. 7) was used to estimate the electrochemically active surface areas of the nanoporous film catalysts. The CDL of FeNi—PSe NFs, FeNi—P NFs, and FeNi—Se NFs was estimated to be 1.29 mF cm⁻², 0.98 mF cm⁻², and 0.42 mF cm⁻² (shown in FIG. 7), respectively, indicating that the FeNi—PSe NFs have a much higher surface area than the other two counterparts for the catalytic reactions.

TABLE 1
System resistance (R_{S}) and charge resistance (R_{CT})
for three samples

| Sample | R_{S} (Ω) | R_{CT} (Ω) |
|---|---|---|
| FeNi—PSe NFs | 1.61 | 1.13 |
| FeNi—P NFs | 1.60 | 1.58 |
| FeNi—Se NFs | 1.62 | 2.15 |

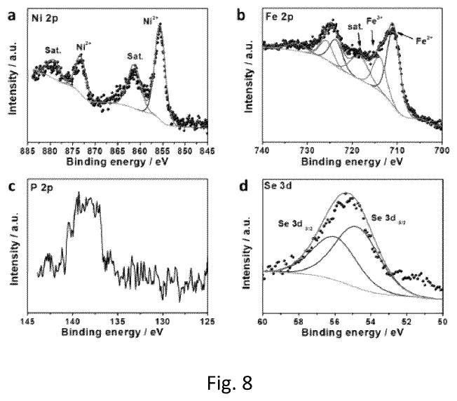

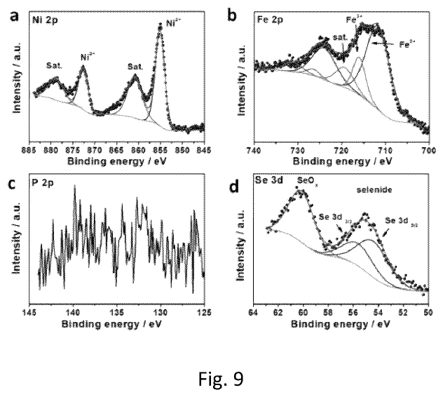

XPS was also performed on the catalysts after long-term HER (as shown in FIG. 8) and OER (as shown in FIG. 9) stability tests, which shows the disappearance of Ni⁰ and Fe⁰ due to the surface reconstruction under harsh conditions (high pH and high polarization) used for water splitting. Similarly, in the XPS P 2p profiles, the metal phosphide phase on the catalyst surface was well preserved during HER (shown in Section C of FIG. 8); however, the phosphide was oxidized to the high valence state P during OER (shown in Section C of FIG. 9). The XPS Se 3d profiles show a similar characteristic to the P 2p, where the core level bands of Se 3d still presents after HER test shown in Section D of FIG. 8) but was oxidized to SeOₓ peaks after OER (Section D of FIG. 9) due to the surface reconstruction.

Traditionally, strongly acidic and alkaline solutions are widely used for water splitting because of the increased ionic conductivities, thus making the dissociation of water quickly and efficiently. According to the pH of the feedstock solutions, water electrolysis is usually categorized into proton and anion exchange membrane (PEM and AEM) electrolyzer. So far, PEM and AEM electrolyzers are still limited by the high cost and low efficiency of PGM catalysts. An ideal and ultimate strategy to replace the traditional electrolyzers operated under harsh conditions (either strongly acidic or alkaline) is to use pure water or even natural seawater as feedstock solutions because they have low corrosion to the electrolyzers and catalysts. Especially, seawater covers 70% surface of the earth crust, which is naturally available for the mass production of H₂ at low cost.

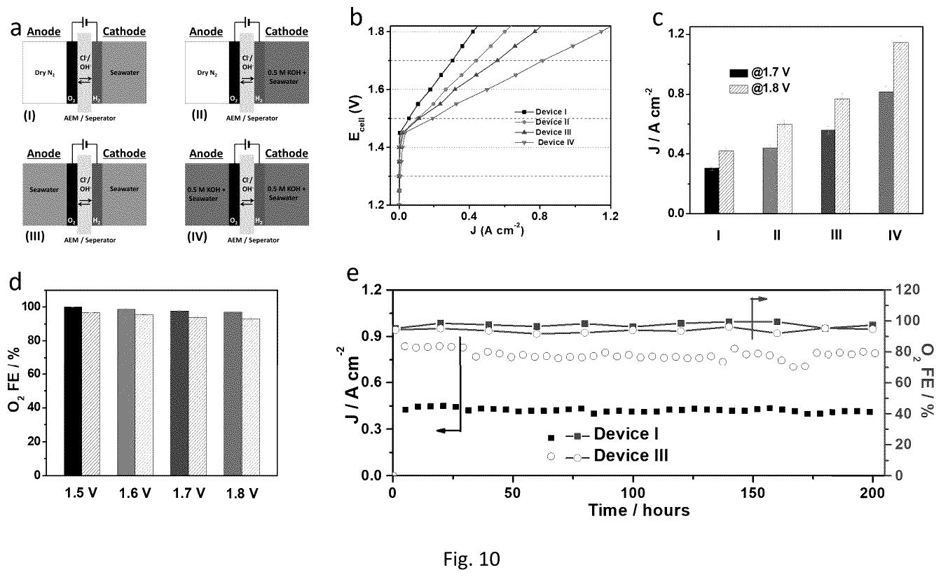

In order to demonstrate the possibility seawater splitting, a practical AEM electrolyzer was employed to explore the performance of the rationally designed FeNi—PSe NFs using four different independent electrolyte feed ways, namely (I-IV) as shown in Section A of FIG. 10. The current densities of 0.305 A cm⁻², 0.44 A cm⁻², 0.559 A cm⁻², and 0.815 A cm⁻² were achieved at an electrolysis voltage of 1.7 V when using (I-IV) feeding modes (Sections B and C of FIG. 10), respectively. The current densities further increased to 0.421 A cm⁻², 0.6 A cm⁻², 0.769 A cm⁻², and 1.144 A cm⁻² for (I-IV), respectively, when the voltage was set at 1.8 V. Noticeably, the seawater electrolysis performance achieved by the FeNi—PSe NFs meet the demanding requirements (0.4-1 A cm⁻²) for the practical application in the industries. Furthermore, the O₂ Faraday efficiency (FE) at 1.8 V using device III was examined by gas chromatography (GC). The O₂ FE over 97% (Section D of FIG. 10, solid histograms) was detected when using natural seawater as the cathode feedstock solution (Section A of FIG. 10, device I). If the conventional symmetric seawater feeding (Section A of FIG. 10, device III) was employed, the O₂ FE above 92% was achieved (Section D of FIG. 10, histograms with inclined pattern). A 200 hour continuous and stable operation of electrolyzer was further demonstrated using the asymmetric (device I in Section A of FIG. 10) and symmetric (device III in Section A of FIG. 10) models of natural seawater feeding (Section E of FIG. 10). During the continuous testing at a cell voltage (E_{cell}) of 1.8 V, well maintained current densities at 0.41 A cm⁻² and 0.8 A cm⁻² with the O₂ FE_{O2} above 95% and 92%, respectively, were obtained. More importantly, the electrolysis efficiency of 78.4% at 1.6V was gained, which is superior to the Department of Energy (DOE) 2020 target (77%).

### Conclusion

The FeNi—PSe NFs show greatly improved activities towards overall water splitting in alkaline solution with overpotentials (η) of 0.17 V and 0.25 V to reach a current density of 10 mA cm⁻² for HER and OER, respectively. Moreover, the turnover frequency (TOF) for OER at η of 0.3 Vis 3.48 s⁻¹, which is 2.3 times higher than that of IrO₂. When used as bifunctional catalysts in an actual water electrolyzer using pure water and even seawater as feedstock solutions, an electrolysis efficiency of 78.4% was obtained, higher than those of the state-of-the-art electrolyzers.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### Glossary of Claim Terms

As used herein, the term “Anodic Conversion” generally refers to an electrochemical oxidation process in which an electrodeposited iron-doped nickel alloy film may be transformed into an iron-doped nickel-oxygen nanofilm. This process can modify the surface composition and structure of the material, forming a precursor that may undergo further chemical treatments such as phosphorization and selenylation. The conversion may enhance the catalytic properties of the nanofilm by increasing its active surface area and electronic conductivity. FIG. 1 of the disclosure illustrates the structural differences between FeNi films, FeNi—O films, and FeNi—PSe nanofilms, highlighting the impact of anodic conversion on material formation.

As used herein, the term “Bifunctional Catalyst” generally refers to a material that can facilitate both the hydrogen evolution reaction (HER) and the oxygen evolution reaction (OER) within an electrochemical system. The quaternary iron-doped nickel phosphoselenide nanoporous film described in the disclosure may function as a bifunctional catalyst by integrating active sites suitable for both HER and OER. The ability of this material to perform these reactions under alkaline conditions may enhance electrolysis efficiency and promote hydrogen production from water splitting. FIG. 6 compares the HER and OER performance of FeNi—PSe nanofilms against Ni—PSe NFs, demonstrating the bifunctional nature of the catalyst.

As used herein, the term “Chemical Vapor Deposition (CVD)” generally refers to a process in which gaseous reactants may be introduced into a reaction chamber to facilitate the chemical transformation of a substrate. In the present disclosure, CVD can be used for the phosphorization and selenylation of an iron-doped nickel-oxygen nanofilm, leading to the formation of a quaternary iron-doped nickel phosphoselenide nanoporous film. The deposition conditions, including temperature and precursor concentrations, may influence the structural properties of the final material. FIG. 3 presents XPS profiles that indicate the incorporation of selenium and phosphorus into the nanofilm during CVD processing.

As used herein, the term “Electrodeposition” generally refers to a method by which a metallic film may be deposited onto a conductive substrate via electrochemical reactions in a liquid electrolyte. This technique can be employed to form an iron-doped nickel alloy film that serves as a precursor for subsequent anodic conversion. The film composition and thickness may be adjusted by modifying the electrolyte composition and deposition parameters. FIG. 2 shows the scanning electron microscopy (SEM) images of electrodeposited films, illustrating their structural morphology before and after subsequent treatments.

As used herein, the term “Electrolysis Efficiency” generally refers to the ability of an electrolyzer to convert electrical energy into chemical energy with minimal losses. In the present disclosure, the electrolysis efficiency of the quaternary iron-doped nickel phosphoselenide nanoporous film can be assessed based on its overpotential, charge transfer resistance, and stability under operational conditions. High electrolysis efficiency may be achieved by optimizing the catalyst structure to facilitate rapid charge transfer and mass transport. FIG. 5 provides data on electrolysis performance, including potential-current density relationships for different electrode configurations.

As used herein, the term “Electrochemical Impedance Spectroscopy (EIS)” generally refers to an analytical technique used to measure the electrical impedance of an electrochemical system over a range of frequencies. In the present disclosure, EIS is used to analyze the charge transfer resistance (RCT) and system resistance (RS) of the synthesized catalysts. The impedance data provide insights into the conductivity, electron transfer kinetics, and catalytic efficiency of the quaternary iron-nickel phosphoselenide nanoporous film.

As used herein, the term “Electron Transfer Process” generally refers to the mechanism by which electrons may be transported during electrochemical reactions. In the context of the disclosed invention, the hydrogen evolution reaction can proceed via a rate-determining step (RDS) that involves electron transfer, with the Heyrovsky step being the dominant mechanism. The efficiency of this process may be influenced by the electronic structure of the catalyst and the availability of active sites. FIG. 4 presents Tafel plots and reaction pathway analyses that elucidate the electron transfer characteristics of the catalyst during HER and OER.

As used herein, the term “Film Thickness” generally refers to the measurable depth of a deposited or treated material layer, which can influence its catalytic performance and durability. The quaternary iron-doped nickel phosphoselenide nanoporous film described herein may have a thickness of approximately 5 μm, as shown in SEM cross-sectional images in FIG. 2. The thickness may affect mass transport, electron conductivity, and mechanical stability, thereby playing a role in optimizing the overall efficiency of water splitting applications.

As used herein, the term “High Valence Nickel” generally refers to nickel species that may exist in oxidation states higher than their metallic form, contributing to improved catalytic activity. The presence of high valence nickel in the quaternary iron-doped nickel phosphoselenide nanoporous film can facilitate oxygen evolution reactions by acting as an active site for electron transfer. The oxidation state of nickel may be influenced by synthesis conditions, as observed in the XPS analysis shown in FIG. 3.

As used herein, the term “Hydrogen Evolution Reaction (HER)” generally refers to an electrochemical reaction in which hydrogen gas may be generated through the reduction of protons or water molecules. This reaction can occur at the cathode of an electrolyzer and may be enhanced by the quaternary iron-doped nickel phosphoselenide nanoporous film. The efficiency of HER may be determined by factors such as overpotential and reaction kinetics, as demonstrated in polarization curves shown in FIG. 4.

As used herein, the term “Iron-Nickel Alloy Matrix” generally refers to a metallic substrate composed of iron and nickel that serves as a structural and conductive support for the electrocatalytic film. In the present disclosure, the iron-nickel alloy matrix remains unreacted beneath the quaternary iron-nickel phosphoselenide nanoporous film, providing mechanical stability and electrical connectivity for the catalyst.

As used herein, the term “Linear Sweep Voltammetry (LSV)” generally refers to an electrochemical technique in which the potential of an electrode is linearly varied over time while measuring the resulting current response. In the present disclosure, LSV is used to evaluate the electrocatalytic performance of the quaternary iron-nickel phosphoselenide nanoporous film by determining onset potentials, overpotentials, and current densities for HER and OER.

As used herein, the term “Mass Transport” generally refers to the movement of reactants and products within a catalytic material, which can influence reaction efficiency. In the present disclosure, the formation of pores in the quaternary iron-doped nickel phosphoselenide nanoporous film may improve mass transport by facilitating the diffusion of hydrogen and oxygen species. Enhanced mass transport can reduce concentration polarization effects, leading to higher catalytic performance. FIG. 2 shows the porous structure of the nanofilm, highlighting its role in improving reaction kinetics.

As used herein, the term “Nanoporous Structure” generally refers to a material architecture that may contain a network of nanoscale pores to enhance catalytic activity. The quaternary iron-doped nickel phosphoselenide nanoporous film described in this disclosure may exhibit a highly porous morphology that facilitates improved electrolyte penetration and increases the density of active reaction sites. The impact of the nanoporous structure on catalyst performance is illustrated in FIG. 6, where electrochemical activity is compared across different material compositions.

As used herein, the term “Overpotential” generally refers to the additional potential beyond the thermodynamic equilibrium potential required to drive an electrochemical reaction. In the present disclosure, overpotential values for HER and OER indicate the efficiency of the quaternary iron-nickel phosphoselenide nanoporous film in reducing energy losses during water splitting.

As used herein, the term “Oxygen Evolution Reaction (OER)” generally refers to an electrochemical process in which oxygen gas may be generated via water oxidation. This reaction can occur at the anode of an electrolyzer and may be facilitated by the quaternary iron-doped nickel phosphoselenide nanoporous film. The performance of the material in OER can be evaluated based on overpotential values, as depicted in the polarization curves in FIG. 4.

As used herein, the term “Overpotential” generally refers to the additional voltage that may be required beyond the thermodynamic equilibrium potential to drive an electrochemical reaction. Lower overpotential values can indicate higher catalytic efficiency. In the present disclosure, the overpotential required for both HER and OER using the quaternary iron-doped nickel phosphoselenide nanoporous film is analyzed in FIG. 4.

As used herein, the term “Phosphorization Treatment” generally refers to a chemical process in which phosphorus may be incorporated into a material to alter its electronic and structural properties. This step can be performed via chemical vapor deposition to convert an iron-doped nickel-oxygen nanofilm into an iron-doped nickel-phosphorus nanofilm, as shown in FIG. 3.

As used herein, the term “Quaternary Iron-Nickel Phosphoselenide Nanoporous Film” generally refers to a catalyst material composed of iron, nickel, phosphorus, and selenium, structured with a nanoporous morphology. In the present disclosure, this film is synthesized through sequential anodic conversion, phosphorization, and selenylation treatments, forming a bifunctional electrocatalyst capable of supporting both HER and OER in electrochemical water splitting applications.

As used herein, the term “Rate-Determining Step (RDS)” generally refers to the slowest step in a multi-step reaction mechanism that dictates the overall reaction rate. In the present disclosure, the RDS for HER in the quaternary iron-nickel phosphoselenide nanoporous film is dominated by the Heyrovsky step, whereas the RDS for OER involves a second-electron transfer process.

As used herein, the term “Selenylation Treatment” generally refers to a chemical process in which selenium is incorporated into a material to alter its electronic and catalytic properties. In the present disclosure, selenylation is performed via chemical vapor deposition to partially substitute phosphorus with selenium in the iron-nickel-phosphorus nanofilm, forming the final quaternary iron-nickel phosphoselenide nanoporous film.

As used herein, the term “Self-Supported Catalyst” generally refers to a catalytic material that does not require additional support structures or binders for mechanical stability. In the present disclosure, the quaternary iron-nickel phosphoselenide nanoporous film is self-supported, eliminating the need for carbon-based additives and allowing direct integration into electrolyzers.

As used herein, the term “Surface Reconstruction” generally refers to structural and compositional changes that occur on the surface of a material during electrochemical operation. In the present disclosure, surface reconstruction of the quaternary iron-nickel phosphoselenide nanoporous film leads to the formation of active sites for HER and OER, enhancing catalytic performance.

As used herein, the term “Tafel Slope” generally refers to a parameter derived from a Tafel plot that quantifies the relationship between the applied potential and the logarithm of current density in an electrochemical reaction. In the present disclosure, the Tafel slope values for HER and OER provide insights into the reaction mechanisms and kinetics of the quaternary iron-nickel phosphoselenide nanoporous film.

As used herein, the term “Turnover Frequency (TOF)” generally refers to the number of catalytic reactions that may occur per active site per unit time. In the present disclosure, TOF values may be used to quantify the catalytic activity of the quaternary iron-doped nickel phosphoselenide nanoporous film for HER and OER, with higher TOF values indicating greater efficiency. FIG. 4 provides a comparative analysis of TOF values for different catalyst formulations.

### Incorporation by Reference

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A method of synthesizing a bifunctional catalyst for water splitting applications, the method comprising:
a) thermally treating an iron-doped nickel-oxygen nanofilm via a phosphorization treatment using bottom-up chemical vapor deposition, forming an iron-doped nickel-phosphorus nanofilm;
b) cooling the iron-doped nickel-phosphorus nanofilm to room temperature for a predetermined period of time;
c) thermally treating the iron-doped nickel-phosphorus nanofilm with selenium vapor via bottom-up chemical vapor deposition to partially substitute selenium for phosphorus, forming a quaternary iron-doped nickel phosphoselenide nanoporous film bifunctional catalyst; and
d) forming a plurality of pores disposed through the quaternary iron-doped nickel phosphoselenide nanoporous film.

2. The method of claim 1, wherein the quaternary iron-doped nickel phosphoselenide nanoporous film comprises high valence nickel.

3. The method of claim 1, wherein the selenium stabilizes the bifunctional catalyst and improves its electrical conductivity.

4. The method of claim 1, wherein the quaternary iron-doped nickel phosphoselenide nanoporous film includes an oxidized surface as an active site for oxygen evolution reactions.

5. The method of claim 1, wherein the rate-determining step for hydrogen evolution reactions is the Heyrovsky step.

6. The method of claim 1, wherein the quaternary iron-doped nickel phosphoselenide nanoporous film includes at least 10 wt % iron, at least 65 wt % nickel, at least 0.5 wt % phosphorus, and at least 23 wt % selenium.

7. The method of claim 1, wherein the quaternary iron-doped nickel phosphoselenide nanoporous film exhibits a turnover frequency of about 3.48 s⁻¹ for oxygen evolution reactions.

8. The method of claim 1, wherein the quaternary iron-doped nickel phosphoselenide nanoporous film includes a thickness of 5 μm.

9. A method of improving electrolysis efficiency during water splitting applications, the method comprising:
a) forming a self-supported quaternary iron-doped nickel phosphoselenide nanoporous film;
b) forming a plurality of pores disposed through the quaternary iron-doped nickel phosphoselenide nanoporous film;
c) subjecting the quaternary iron-doped nickel phosphoselenide nanoporous film to an amount of water;
d) flowing the amount of water through the plurality of pores disposed through the quaternary iron-doped nickel phosphoselenide nanoporous film; and
e) converting the amount of water into hydrogen fuel through hydrogen evolution reactions.

10. The method of claim 9, wherein the quaternary iron-doped nickel phosphoselenide nanoporous film is disposed on a surface of an unreacted iron-nickel alloy matrix.

11. The method of claim 9, wherein the quaternary iron-doped nickel phosphoselenide nanoporous film exhibits a rate-determining second-electron transfer process for hydrogen evolution reactions.

12. The method of claim 9, wherein the quaternary iron-doped nickel phosphoselenide nanoporous film comprises high valence nickel.

13. The method of claim 9, wherein the selenium stabilizes the bifunctional catalyst.

14. The method of claim 9, wherein the electrolysis reaction is maintained for at least 100,000 seconds under alkaline conditions.

15. A method of synthesizing a high-efficiency bifunctional electrocatalyst, the method comprising:
a) performing a top-down anodic conversion of an iron-doped nickel alloy film to form an iron-doped nickel-oxygen nanofilm;
b) thermally treating the iron-doped nickel-oxygen nanofilm via a phosphorization treatment using bottom-up chemical vapor deposition, forming an iron-doped nickel-phosphorus nanofilm;
c) cooling the iron-doped nickel-phosphorus nanofilm to room temperature for a predetermined period of time;
d) thermally treating the iron-doped nickel-phosphorus nanofilm with selenium vapor via bottom-up chemical vapor deposition to partially substitute selenium for phosphorus, forming a quaternary iron-doped nickel phosphoselenide nanoporous film bifunctional catalyst; and
e) disposing the quaternary iron-doped nickel phosphoselenide nanoporous film on at least one portion of a surface of an unreacted iron-nickel alloy.

16. The method of claim 15, further comprising forming a plurality of pores disposed through the quaternary iron-doped nickel phosphoselenide nanoporous film.

17. The method of claim 16, further comprising subjecting the quaternary iron-doped nickel phosphoselenide nanoporous film to an amount of water.

18. The method of claim 17, further comprising flowing the amount of water through the plurality of pores disposed through the quaternary iron-doped nickel phosphoselenide nanoporous film.

19. The method of claim 17, further comprising converting, via hydrogen evolution reactions, the amount of water into hydrogen fuel.

20. The method of claim 17, wherein the quaternary iron-doped nickel phosphoselenide nanoporous film exhibits a turnover frequency of about 3.48 s⁻¹ for oxygen evolution reactions.
